(19) United States
(12) Patent Application Publication
(10) Pub. No.: US 2022/0352756 A1
(43) Pub. Date: Nov. 3, 2022

(54) Wireless Power Transfer Apparatus for TWS Phone

(71) Applicant: Nuvolta Technologies (Hefei) Co., Ltd., Hefei (CN)

(72) Inventors: Zhengyu Li, Shanghai (CN); Zeng Li, Shanghai (CN)

(21) Appl. No.: 17/325,506

(22) Filed: May 20, 2021

(30) Foreign Application Priority Data
Apr. 29, 2021 (CN) 202110471796.9

(51) Int. Cl. H02J 50/12; H02J 50/40; H02J 7/00

(52) U.S. Cl. CPC H02J 50/12; H02J 50/40; H02J 7/0013; H02J 7/0044; H02J 7/0047; H02J 7/007182; H02J 2207/20; H04R 2420/07

(57) ABSTRACT

A wireless power transfer apparatus includes a first switching leg connected between a first voltage bus and ground, a first transmitter coil coupled between a midpoint of the first switching leg and ground, wherein the first transmitter coil is configured to provide power for a first charger through a first receiver, a second switching leg connected between a second voltage bus and ground, and a second transmitter coil coupled between a midpoint of the second switching leg and ground, wherein the second transmitter coil is configured to provide power for a second charger through a second receiver.

### PRIORITY CLAIM

This application claims priority to Chinese Patent Application No. 202110471796.9, filed on Apr. 29, 2021, which is hereby incorporated by reference in its entirety.

### TECHNICAL FIELD

The present invention relates to a wireless power transfer apparatus, and, in particular embodiments, to a wireless power transfer apparatus for charging true wireless stereo (TWS) phones.

### BACKGROUND

As technologies further advance, wireless power transfer has emerged as an efficient and convenient mechanism for powering or charging battery based mobile devices such as mobile phones, tablet PCs, digital cameras, MP3 players and/or the like. A wireless power transfer system typically comprises a primary side transmitter and a secondary side receiver. The primary side transmitter is magnetically coupled to the secondary side receiver through a magnetic coupling. The magnetic coupling may be implemented as a loosely coupled transformer having a primary side coil formed in the primary side transmitter and a secondary side coil formed in the secondary side receiver.

The primary side transmitter may comprise a power conversion unit such as a primary side of a power converter. The power conversion unit is coupled to a power source and is capable of converting electrical power to wireless power signals. The secondary side receiver is able to receive the wireless power signals through the loosely coupled transformer and convert the received wireless power signals to electrical power suitable for a load.

True wireless stereo (TWS) phones have emerged to the forefront of audio technology and become ubiquitous after more and more mobile phone users have stared using them. A battery box is typically needed to match with a pair of TWS phones. The battery box functions as a storage box. Furthermore, the battery box also functions as a charging box for supplying power to the pair of TWS phones. However, the existing battery box is inefficient to charge the TWS phones. It would be desirable to have a simple and reliable TWS phone charging apparatus to provide an efficient charging for TWS phones under a variety of operating conditions.

### SUMMARY

These and other problems are generally solved or circumvented, and technical advantages are generally achieved, by preferred embodiments of the present disclosure which provide a wireless power transfer apparatus for charging true wireless stereo (TWS) phones.

In accordance with an embodiment, an apparatus comprises a first switching leg connected between a first voltage bus and ground, a first transmitter coil coupled between a midpoint of the first switching leg and ground, wherein the first transmitter coil is configured to provide power for a first charger through a first receiver, a second switching leg connected between a second voltage bus and ground, and a second transmitter coil coupled between a midpoint of the second switching leg and ground, wherein the second transmitter coil is configured to provide power for a second charger through a second receiver.

In accordance with another embodiment, a method comprises providing power to a first transmitter coil and a second transmitter coil through a first switching leg and a second switching leg of a full bridge, respectively, charging a first TWS phone using a first charger coupled to a first receiver coil magnetically coupled to the first transmitter coil, and charging a second TWS phone using a second charger coupled to a second receiver coil magnetically coupled to the second transmitter coil, and adjusting at least one switching frequency of the first switching leg and the second switching leg to regulate a voltage fed into a corresponding charger, wherein a voltage difference between the voltage fed into the corresponding charger and a voltage across a battery of a corresponding TWS phone is reduced so as to reduce a power loss of the corresponding charger.

In accordance with yet another embodiment, a system comprises a first TWS phone configured to be placed in a first slot of a battery box, wherein the first TWS phone comprises a first receiver coil, a first receiver switch network and a first charger, a second TWS phone configured to be placed in a second slot of the battery box, wherein the second TWS phone comprises a second receiver coil, a second receiver switch network and a second charger, and the battery box comprising a battery, a full bridge having inputs coupled to the battery, a first transmitter coil and a second transmitter coil, wherein the battery is configured to provide power to the first TWS phone and the second TWS phone wirelessly.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a wireless power transfer system for TWS phones in accordance with various embodiments of the present disclosure;

FIG. 2 illustrates a schematic diagram of the wireless power transfer system shown in FIG. 1 in accordance with various embodiments of the present disclosure;

FIG. 3 illustrates a first arrangement of the transmitter coils and the receiver coils shown in FIG. 2 in accordance with various embodiments of the present disclosure; and

FIG. 4 illustrates a second arrangement of the transmitter coils and the receiver coils shown in FIG. 2 in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context, namely a wireless power transfer apparatus for charging true wireless stereo (TWS) phones. The invention may also be applied, however, to a variety of wireless charging systems. Hereinafter, various embodiments will be explained in detail with reference to the accompanying drawings.

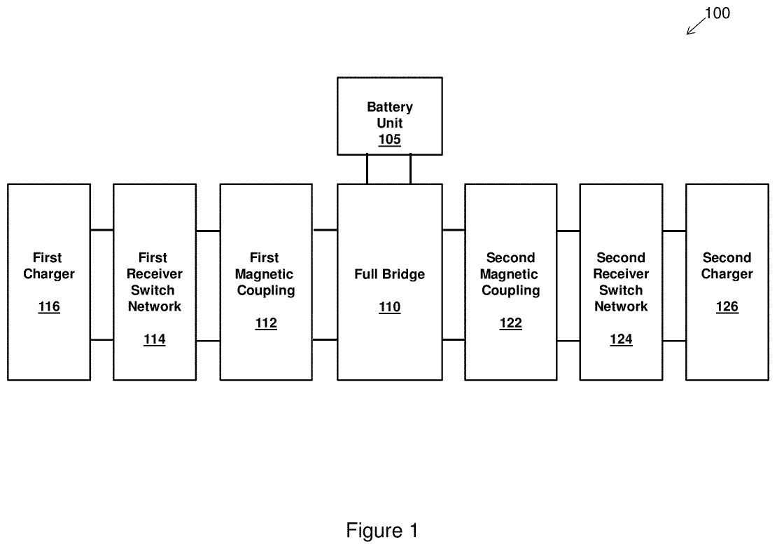

FIG. 1 illustrates a block diagram of a wireless power transfer system for TWS phones in accordance with various embodiments of the present disclosure. The wireless power transfer system 100 comprises a battery unit 105, a full bridge 110, a first magnetic coupling 112, a first receiver switch network 114, a first charger 116, a second magnetic coupling 122, a second receiver switch network 124 and a second charger 126.

The wireless power transfer system 100 is employed to charge a pair of TWS phones. In some embodiments, a portion of the wireless power transfer system 100 shown in FIG. 1 is in a battery box. The rest of the wireless power transfer system 100 is in the TWS phones. The battery box comprises a first slot and a second slot. The first slot is configured to accommodate a first TWS phone. After the first TWS phone is inserted into the first slot, power is transferred wirelessly from the battery of the battery box to the first TWS phone to charge the depleted battery of the first TWS phone. The second slot is configured to accommodate a second TWS phone. After the second TWS phone is inserted into the second slot, power is transferred wirelessly from the battery of the battery box to the second TWS phone to charge the depleted battery of the second TWS phone.

It should be noted that the TWS phone charging apparatus and method described above do not require metal contacts as an interface between the TWS phones and the battery box. The power can be wirelessly transferred between the battery box and the TWS phones.

The battery unit 105 comprises a battery placed in the battery box. The battery is used to provide power for wirelessly charging the batteries of the TWS phones. The battery unit 105 may further comprise a plurality of control circuits for controlling the operation of the battery box.

The full bridge 110 comprises a first switching leg and a second switching leg. Both the first switching leg and the second switching leg comprise two switches connected in series between the output terminal of the battery of the battery unit 105 and ground. The first switching leg is employed to convert a dc voltage (the output voltage of the battery) into a first ac voltage. The first ac voltage is applied to the first magnetic coupling 112. As a result of applying the first ac voltage to the first magnetic coupling 112, the power is transferred from the battery of the battery box to the first TWS phone. Likewise, the second switching leg is employed to convert the dc voltage (the output voltage of the battery) into a second ac voltage. The second ac voltage is applied to the second magnetic coupling 122. As a result of applying the second ac voltage to the second magnetic coupling 122, the power is transferred from the battery of the battery box to the second TWS phone.

The first magnetic coupling 112 is formed by a first transmitter coil and a first receiver coil. The first transmitter coil is wound around an interior sidewall of a first slot of the battery box. The first receiver coil is inside the first TWS phone. The second magnetic coupling 122 is formed by a second transmitter coil and a second receiver coil. The second transmitter coil is wound around an interior sidewall of a second slot of the battery box. The second receiver coil is inside the second TWS phone.

The first receiver switch network 114 may be implemented as a first half bridge comprising two switches connected in series. The first half bridge functions as a first rectifier configured to convert an alternating polarity waveform received from the output of the first receiver coil to a single polarity waveform fed into the first charger 116. The first charger 116 may be implemented as any suitable chargers such as a buck converter based charger, a linear regulator based charger, a charge pump converter based charger, any combinations thereof and the like. The first charger 116 is employed to charge the rechargeable battery of the first TWS phone.

The second receiver switch network 124 may be implemented as a second half bridge comprising two switches connected in series. The second half bridge functions as a second rectifier configured to convert an alternating polarity waveform received from the output of the second receiver coil to a single polarity waveform fed into the second charger 126. The second charger 126 may be implemented as any suitable chargers such as a buck converter based charger, a linear regulator based charger, a charge pump converter based charger, any combinations thereof and the like. The second charger 126 is employed to charge the rechargeable battery of the second TWS phone.

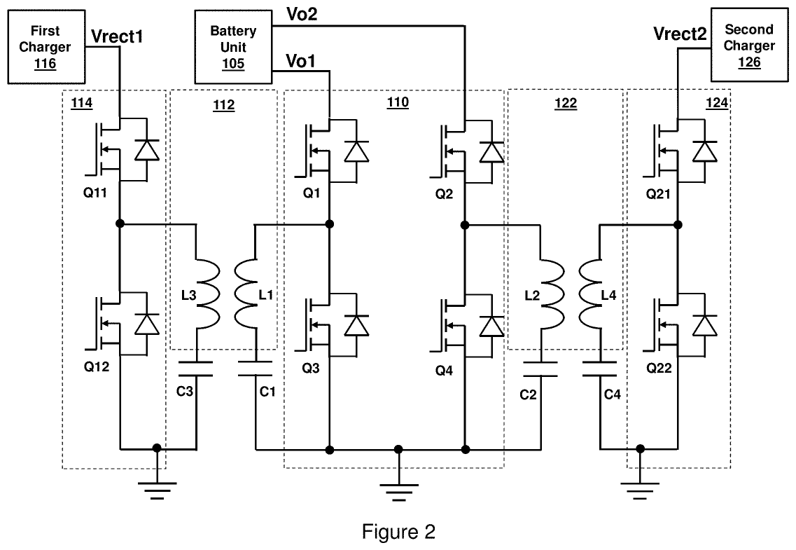

The full bridge and half bridges described above may be formed by any controllable devices such as metal oxide semiconductor field effect transistor (MOSFET) devices, bipolar junction transistor (BJT) devices, super junction transistor (SJT) devices, insulated gate bipolar transistor (IGBT) devices, gallium nitride (GaN) based power devices and/or the like. The detailed structure of the full bridge and half bridges will be discussed below with respect to FIG. 2.

FIG. 2 illustrates a schematic diagram of the wireless power transfer system shown in FIG. 1 in accordance with various embodiments of the present disclosure. The wireless power transfer system comprises a full bridge 110, a first magnetic coupling 112, a first receiver switch network 114, a first charger 116, a second magnetic coupling 122, a second receiver switch network 124 and a second charger 126. The wireless power transfer system further comprises a first transmitter resonant capacitor C1, a second transmitter resonant capacitor C2, a first receiver resonant capacitor C3 and a second receiver resonant capacitor C4. The resonant capacitors C1-C4 help to achieve soft switching for the wireless power transfer system.

The full bridge 110 includes four switches, namely Q1, Q2, Q3 and Q4. The four switches form two switching leg. As shown in FIG. 2, the first switching leg comprises a first switch Q1 and a third switch Q3 connected in series between a first voltage bus Vo1 and ground. The second switching leg comprises a second switch Q2 and a fourth switch Q4 connected in series between a second voltage bus Vo2 and ground. As shown in FIG. 2, the first voltage bus Vo1 and the second voltage bus Vo2 are two output terminals of a battery unit 105. In some embodiments, both the first voltage bus Vo1 and the second voltage bus Vo2 are connected to a battery in the battery unit 105. Alternatively, there may be two batteries in the battery unit. These two batteries are connected to the first voltage bus Vo1 and the second voltage bus Vo2, respectively. Throughout the description, a common node of the first switch Q1 and the third switch Q3 may be alternatively referred to as a midpoint of the first switching leg. A common node of the second switch Q2 and the fourth switch Q4 may be alternatively referred to as a midpoint of the second switching leg.

The first magnetic coupling 112 is formed by a first transmitter coil L1 and a first receiver coil L3. The second magnetic coupling 122 is formed by a second transmitter coil L2 and a second receiver coil L4. As shown in FIG. 2, the first transmitter coil L1 and a first transmitter resonant capacitor C1 are connected in series with between the midpoint of the first switching leg and ground. The second transmitter coil L2 and a second transmitter resonant capacitor C2 are connected in series with between the midpoint of the second switching leg and ground.

The first receiver switch network 114 is a first half bridge comprising a first receiver switch Q11 and a second receiver switch Q12 connected in series between an input of the first charger 116 and ground. The first receiver switch network 114 functions as a rectifier converting an alternating polarity waveform received from the outputs of the first receiver coil L3 to a single polarity waveform fed into the first charger 116. A capacitor (not shown) may be coupled to the input of the first charger 116 for attenuating noise so as to provide a steady voltage for the first charger 116.

The second receiver switch network 124 is a second half bridge comprising a third receiver switch and a fourth receiver switch connected in series between an input of the second charger and ground. The second receiver switch network 124 functions as a rectifier converting an alternating polarity waveform received from the outputs of the second receiver coil L4 to a single polarity waveform fed into the second charger 126. A capacitor (not shown) may be coupled to the input of the second charger 126 for attenuating noise so as to provide a steady voltage for the second charger 126.

The first receiver coil L3 and a first receiver resonant capacitor C3 are connected in series between a common node of the first receiver switch Q11 and the second receiver switch Q12, and ground. The second receiver coil L4 and a second receiver resonant capacitor C4 are connected in series between a common node of the third receiver switch Q21 and the fourth receiver switch Q22, and ground.

In FIG. 2, the full bridge 110, the first transmitter coil L1, the second transmitter coil L2, the first transmitter resonant capacitor C1 and the second transmitter resonant capacitor C2 are placed in a transmitter. In some embodiments, this transmitter is inside the battery box. The first receiver coil L3, the first receiver resonant capacitor C3 and the first receiver switch network 114 are placed in a first receiver. In some embodiments, the first receiver is inside the first TWS phone. The second receiver coil L4, the second receiver resonant capacitor C4 and the second receiver switch network 124 are placed in a second receiver. In some embodiments, the second receiver is inside the second TWS phone.

According to some embodiments, the switches Q1, Q2, Q3, Q4, Q11, Q12, Q13 and Q14 are implemented as MOSFET or MOSFETs connected in parallel, any combinations thereof and/or the like. According to alternative embodiments, the switching elements (e.g., switch Q1) may be an insulated gate bipolar transistor (IGBT) device. Alternatively, the primary switches can be any controllable switches such as integrated gate commutated thyristor (IGCT) devices, gate turn-off thyristor (GTO) devices, silicon controlled rectifier (SCR) devices, junction gate field-effect transistor (JFET) devices, MOS controlled thyristor (MCT) devices, gallium nitride (GaN) based power devices and/or the like.

It should further be noted that while FIG. 2 illustrates a full bridge having four switches Q1-Q4, various embodiments of the present disclosure may include other variations, modifications and alternatives. For example, a separate capacitor may be connected in parallel with each switch of the full bridge 110. Such a separate capacitor helps to better control the timing of the resonant process of the full bridge 110.

In some embodiments, the battery unit 105, the full bridge 110, the first transmitter coil L1 and the second transmitter coil L2 are in the battery box. The battery box has two slots. Each slot is configured to provide battery charging for one TWS phone. The first receiver coil L3, the first receiver resonant capacitor C3, the first receiver switch network 114 and the first charger are in the first TWS phone. The second receiver coil L4, the second receiver resonant capacitor C4, the second receiver switch network 124 and the second charger are in the second TWS phone.

The battery box may comprise at least one printed circuit board (PCB). The full bridge 110 and the associated control circuits are mounted on the PCB. The first transmitter coil L1 may be wound around an interior sidewall of a first slot of the battery box. After the first TWS phone is placed in the first slot of the battery box, the first transmitter coil L1 is magnetically coupled to the first receiver coil placed inside the first TWS phone. In other words, a magnetic coupling is established between the first transmitter coil L1 and the first receiver coil L3 Likewise, the second transmitter coil L2 may be wound around an interior sidewall of a second slot of the battery box. After the second TWS phone is placed in the second slot of the battery box, the second transmitter coil L2 is magnetically coupled to the second receiver coil L4 placed inside the second TWS phone. A magnetic coupling is established between the second transmitter coil L2 and the second receiver coil L4.

In some embodiments, the voltage of the battery in the battery unit 105 has an output voltage varying in a range from about 3.4 V to about 4.4 V. The voltage of the battery in the first TWS phone has a voltage varying in a range from about 3.4 V to about 4.4 V. The voltage of the battery in the second TWS phone has a voltage varying in a range from about 3.4 V to about 4.4 V. The battery in the battery unit 105 is capable of charging the batteries in the TWS phone through adjusting the system gains of the wireless power transfer system.

As shown in FIG. 2, the ratio of Vrect1 to Vo1 is defined as a first system gain. The ratio of Vrect2 to Vo2 is defined as a second system gain. The first system gain can be adjusted through adjusting the switching frequency of the first switching leg. For example, the switching frequency of the first switching leg is in a range from about 300 KHz to about 450 KHz. When the switching frequency is going up, the first system gain is reduced. For example, when the switching frequency is 450 KHz, the first system gain is about 0.85. On the other hand, when the switching frequency is going down, the first system gain is increased. For example, when the switching frequency is 300 KHz, the first system gain is in a range from about 1.2 to about 1.3. The second system gain can be adjusted in a manner similar to the first system gain, and hence is not discussed again herein.

It should be noted that the system gain can also be adjusted by adjusting the duty cycle of the switches (e.g., the duty cycle of Q1). When the duty cycle is high, the system gain is increased. On the other hand, when the duty cycle is low, the system gain is reduced. The duty cycle adjustment and the switching frequency adjustment described above can be taken individually or in combination to adjust the system gain.

In operation, after the first TWS phone and the second TWS phone have been inserted into the first slot and the second slot of the battery box respectively, a first magnetic coupling is established between the first transmitter coil L1 and the first receiver coil L3, and a second magnetic coupling is established between the second transmitter coil L3 and the second receiver coil L4. Prior to wirelessly transferring power from the transmitter coils to the receiver coils, a controller (not shown) may first detect the voltages across the batteries of the TWS phones. Based on the detected voltages of the batteries of the TWS phones, the controller may determine the switching frequencies of the two switching legs. More particularly, based on the voltage across the battery of the first TWS phone, the controller determines a first system gain so that the voltage (Vrect1) fed into the first charger 116 is slightly higher than the voltage across the battery of the first TWS phone. The voltage Vrect1 can be adjusted or regulated through adjusting the switching frequency of the first switching leg. In some embodiments, through adjusting the switching frequency of the first switching leg, a voltage difference between the voltage fed into the first charger 116 and the voltage across the battery of the first TWS phone is reduced so as to reduce a power loss of the first charger 116.

One advantageous feature of regulating Vrect1 to a voltage level slightly higher than the voltage across the battery of the first TWS phone is the power loss in the first charger 116 can be significantly reduced. For example, the first charger 116 may be implemented as a linear regulator. After regulating Vrect1 to a voltage level slightly higher than the voltage across the battery of the first TWS phone, the voltage drop across the linear regulator has been reduced. Such a reduced voltage drop helps to improve the efficiency of the first charger 116, thereby achieving best efficiency tracking of the first charger 116.

Likewise, based on the voltage across the battery of the second TWS phone, the controller determines a second system gain so that the voltage (Vrect2) fed into the second charger 126 is slightly higher than the voltage across the battery of the second TWS phone. The voltage Vrect2 can be adjusted or regulated through adjusting the switching frequency of the second switching leg. In some embodiments, through adjusting the switching frequency of the second switching leg, a voltage difference between the voltage fed into the second charger 126 and the voltage across the battery of the second TWS phone is reduced so as to reduce a power loss of the second charger 126. One advantageous feature of regulating Vrect2 to a voltage level slightly higher than the voltage across the battery of the second TWS phone is the power loss in the second charger 126 can be significantly reduced. For example, the second charger 126 may be implemented as a linear regulator. After regulating Vrect2 to a voltage level slightly higher than the voltage across the battery of the second TWS phone, the voltage drop across the linear regulator has been reduced. Such a reduced voltage drop helps to improve the efficiency of the second charger 126, thereby achieving best efficiency tracking of the second charger 126.

It should be noted that the switching frequencies of the first switching leg and the second switching leg can be independently adjusted. When the battery voltage of the first TWS phone is different from that of the second TWS phone, the switching frequency of the first switching leg is different from the switching frequency of the second switching leg. In some embodiments, the first switching leg and the second switching leg are interleaved to reduce the ripple.

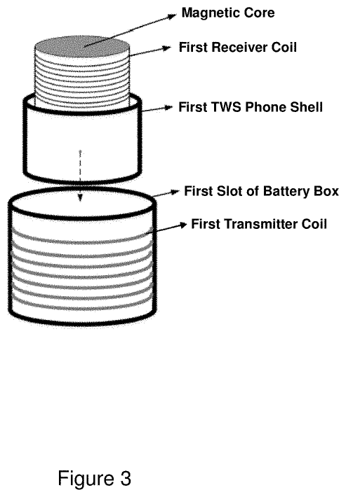

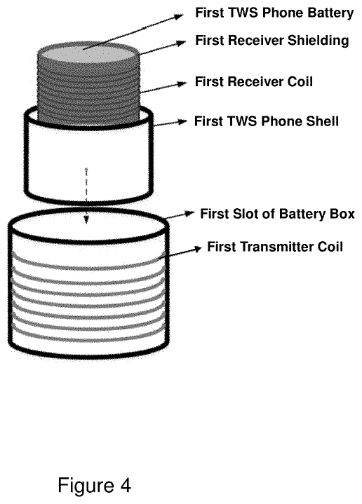

As shown in FIG. 2, there are two pairs of coils. The first transmitter coil is magnetically coupled to the first receiver coil. The second transmitter coil is magnetically coupled to the second receiver coil. In some embodiments, the first transmitter coil and the second transmitter coil are placed inside the battery box. The first receiver coil is in a first TWS phone. The second receiver coil is in a second TWS phone. The battery box has two slots configured to accommodate two TWS phones respectively. The first transmitter coil is placed adjacent to a first slot and configured to be magnetically coupled to the first receiver coil after the first TWS phone is inserted into the first slot. The second transmitter coil is placed adjacent to a second slot and configured to be magnetically coupled to the second receiver coil after the second TWS phone is inserted into the second slot. The arrangement of a transmitter coil and a corresponding receiver coil will be discussed in detail with respect to FIGS. 3-4.

FIG. 3 illustrates a first arrangement of the transmitter coils and the receiver coils shown in FIG. 2 in accordance with various embodiments of the present disclosure. The two pairs of coils shown in FIG. 2 have the same arrangement. For simplicity, the first transmitter coil L1 and the first receiver coil L3 are selected to illustrate the configuration of the transmitter coils and the receiver coils.

As shown in FIG. 3, the first transmitter coil is wound around a sidewall of a host device. The host device is the first slot of the battery box. As shown in FIG. 3, the first transmitter coil is wound around an interior sidewall of the first slot of the battery box. The first receiver coil is wound around a sidewall of a first magnetic core. As shown in FIG. 3, the first magnetic core is placed inside the shell of the first TWS phone. After the first TWS phone is inserted into the first slot of the battery box, the first receiver coil and the first magnetic core are in the first slot. The first receiver coil is magnetically coupled to the first transmitter coil. The first magnetic core helps to enhance the magnetic coupling between the first receiver coil and the first transmitter coil. In some embodiments, the first magnetic core is formed of any suitable ferrite core materials.

FIG. 4 illustrates a second arrangement of the transmitter coils and the receiver coils shown in FIG. 2 in accordance with various embodiments of the present disclosure. The second arrangement shown in FIG. 4 is similar to that shown in FIG. 3 except that the first magnetic core is replaced by the battery of the first TWS phone. As shown in FIG. 4, the first receiver coil is wound around a sidewall of the battery of the first TWS phone. A first receiver shielding layer may be placed between the first receiver coil and the sidewall of the battery of the first TWS phone. As shown in FIG. 4, the battery is placed inside the shell of the first TWS phone. After the first TWS phone is inserted into the first slot, the first receiver coil and the battery are in the first slot. The first receiver coil is magnetically coupled to the first transmitter coil.

It should be noted there may be a magnetic material layer placed between the shell of the first TWS phone and the battery of the first TWS phone. In some embodiments, the magnetic material layer may be formed of Nano Crystalline soft magnetic materials.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus comprising:
a first switching leg connected between a first voltage bus and ground;
a first transmitter coil coupled between a midpoint of the first switching leg and ground, wherein the first transmitter coil is configured to provide power for a first charger through a first receiver;
a second switching leg connected between a second voltage bus and ground; and
a second transmitter coil coupled between a midpoint of the second switching leg and ground, wherein the second transmitter coil is configured to provide power for a second charger through a second receiver.

2. The apparatus of claim 1, wherein:
the first switching leg comprises a first switch and a third switch connected in series, wherein the midpoint of the first switching leg is a common node of the first switch and the third switch; and
the second switching leg comprises a second switch and a fourth switch connected in series, wherein the midpoint of the second switching leg is a common node of the second switch and the fourth switch.

3. The apparatus of claim 1, wherein:
the first voltage bus is a first output of a battery unit; and
the second voltage bus is a second output of the battery unit.

4. The apparatus of claim 1, further comprising:
a first transmitter resonant capacitor connected in series with the first transmitter coil between the midpoint of the first switching leg and ground; and
a second transmitter resonant capacitor connected in series with the second transmitter coil between the midpoint of the second switching leg and ground.

5. The apparatus of claim 1, wherein:
the first receiver comprises a first receiver coil, a first receiver resonant capacitor and a first receiver switch network;
the second receiver comprises a second receiver coil, a second receiver resonant capacitor and a second receiver switch network;
the first charger is configured to charge a battery of a first true wireless stereo (TWS) phone; and
the second charger is configured to charge a battery of a second TWS phone.

6. The apparatus of claim 5, wherein:
the first receiver switch network is a first half bridge comprising a first receiver switch and a second receiver switch connected in series between an input of the first charger and ground; and
the second receiver switch network is a second half bridge comprising a third receiver switch and a fourth receiver switch connected in series between an input of the second charger and ground.

7. The apparatus of claim 6, wherein:
the first receiver coil and the first receiver resonant capacitor are connected in series between a common node of the first receiver switch and the second receiver switch, and ground; and
the second receiver coil and the second receiver resonant capacitor are connected in series between a common node of the third receiver switch and the fourth receiver switch, and ground.

8. The apparatus of claim 6, wherein:
the first transmitter coil is wound around an interior sidewall of a slot of a host device; and
the first receiver coil is wound around a sidewall of a first magnetic core, and wherein the first magnetic core is configured to be placed in the slot of the host device.

9. The apparatus of claim 6, wherein:
the first transmitter coil is wound around an interior sidewall of a slot of a host device; and
the first receiver coil is wound around a sidewall of the battery of the first TWS phone, and wherein the first TWS phone is configured to be placed in the slot of the host device.

10. The apparatus of claim 6, wherein:
the first TWS phone is placed in a first slot of a battery box; and
the second TWS phone is placed in a second slot of the battery box, and wherein:
the battery box is configured to charge the first TWS phone wirelessly through a first magnetic coupling formed by the first transmitter coil and the first receiver coil; and
the battery box is configured to charge the second TWS phone wirelessly through a second magnetic coupling formed by the second transmitter coil and the second receiver coil.

11. A method comprising:
providing power to a first transmitter coil and a second transmitter coil through a first switching leg and a second switching leg of a full bridge, respectively;
charging a first TWS phone using a first charger coupled to a first receiver coil magnetically coupled to the first transmitter coil, and charging a second TWS phone using a second charger coupled to a second receiver coil magnetically coupled to the second transmitter coil; and
adjusting at least one switching frequency of the first switching leg and the second switching leg to regulate a voltage fed into a corresponding charger, wherein a voltage difference between the voltage fed into the corresponding charger and a voltage across a battery of a corresponding TWS phone is reduced so as to reduce a power loss of the corresponding charger.

12. The method of claim 11, wherein:
the first switching leg comprises a first switch and a third switch connected in series;
the second switching leg comprises a second switch and a fourth switch connected in series;
the first transmitter coil is coupled between a common node of the first switch and the third switch, and ground; and
the second transmitter coil is coupled between a common node of the third switch and the fourth switch, and ground.

13. The method of claim 11, further comprising:
detecting a voltage across a battery of the first TWS phone and a voltage across a battery of the second TWS phone;
adjusting a switching frequency of the first switching leg so as to regulate a voltage fed into the first charger, wherein as a result of adjusting the switching frequency of the first switching leg, a voltage difference between the voltage fed into the first charger and the voltage across the battery of the first TWS phone is reduced so as to reduce a power loss of the first charger; and
adjusting a switching frequency of the second switching leg so as to regulate a voltage fed into the second charger, wherein as a result of adjusting the switching frequency of the second switching leg, a voltage difference between the voltage fed into the second charger and the voltage across the battery of the second TWS phone is reduced so as to reduce a power loss of the second charger.

14. The method of claim 11, further comprising:
charging the first TWS phone through a first receiver switch network and the first charger, wherein the first receiver switch network is coupled between the first receiver coil and the first charger; and
charging the second TWS phone through a second receiver switch network and the second charger, wherein the second receiver switch network is coupled between the second receiver coil and the second charger, wherein:
the first receiver switch network is a first half bridge comprising a first receiver switch and a second receiver switch connected in series between an input of the first charger and ground, and wherein the first receiver coil and a first receiver resonant capacitor are connected in series between a common node of the first receiver switch and the second receiver switch, and ground; and
the second receiver switch network is a second half bridge comprising a third receiver switch and a fourth receiver switch connected in series between an input of the second charger and ground, and wherein the second receiver coil and a second receiver resonant capacitor are connected in series between a common node of the third receiver switch and the fourth receiver switch, and ground.

15. A system comprising:
a first TWS phone configured to be placed in a first slot of a battery box, wherein the first TWS phone comprises a first receiver coil, a first receiver switch network and a first charger;
a second TWS phone configured to be placed in a second slot of the battery box, wherein the second TWS phone comprises a second receiver coil, a second receiver switch network and a second charger; and
the battery box comprising a battery, a full bridge having inputs coupled to the battery, a first transmitter coil and a second transmitter coil, wherein the battery is configured to provide power to the first TWS phone and the second TWS phone wirelessly.

16. The system of claim 15, wherein:
the first transmitter coil is wound around an interior sidewall of the first slot of the battery box; and
the first receiver coil is wound around a sidewall of a first magnetic core, and wherein the first magnetic core is configured to be placed in the first slot of the battery box.

17. The system of claim 16, wherein:
the first transmitter coil is magnetically coupled to the first receiver coil after the first TWS phone is placed in the first slot of the battery box.

18. The system of claim 15, wherein:
the first transmitter coil is wound around an interior sidewall of the first slot of the battery box; and
the first receiver coil is wound around a battery of the first TWS phone, and wherein the first TWS phone is configured to be placed in the first slot of the battery box.

19. The system of claim 15, wherein the full bridge comprises a first switching leg and a second switching leg, and wherein:
the first switching leg comprises a first switch and a third switch connected in series;
the second switching leg comprises a second switch and a fourth switch connected in series;
the first transmitter coil is coupled between a common node of the first switch and the third switch, and ground; and
the second transmitter coil is coupled between a common node of the third switch and the fourth switch, and ground.

20. The system of claim 15, wherein:
the first receiver switch network is a first half bridge comprising a first receiver switch and a second receiver switch connected in series between an input of the first charger and ground, and wherein the first receiver coil and a first receiver resonant capacitor are connected in series between a common node of the first receiver switch and the second receiver switch, and ground; and
the second receiver switch network is a second half bridge comprising a third receiver switch and a fourth receiver switch connected in series between an input of the second charger and ground, and wherein the second receiver coil and a second receiver resonant capacitor are connected in series between a common node of the third receiver switch and the fourth receiver switch, and ground.
